(19) United States
(12) Patent Application Publication
(10) Pub. No.: US 2019/0061820 A1
(43) Pub. Date: Feb. 28, 2019

(54) AUXILIARY FRAME FOR MOTOR VEHICLES

(71) Applicant: KSM Castings Group GmbH, Hildesheim (DE)

(72) Inventors: Heiko KAUERT, Blankenfelde (DE); Heik LACHMUND, Holle (DE)

(73) Assignee: KSM Castings Group GmbH, Hildesheim (DE)

(21) Appl. No.: 15/742,954

(22) PCT Filed: Jun. 20, 2016
(86) PCT No.: PCT/DE2016/100278

§ 371 Date: Jan. 9, 2018

(30) Foreign Application Priority Data
Jul. 10, 2015 (DE) 10 2015 111 219.1
Feb. 5, 2016 (DE) 10 2016 102 039.7

(51) Int. Cl. B62D 21/11; B60K 1/00; B60K 17/00

(52) U.S. Cl. CPC B62D 21/11; B60K 17/00; B60K 1/00

(57) ABSTRACT

An auxiliary frame for a rear axle, in particular a multi-link rear axle of a motor vehicle.

The invention relates to an auxiliary frame for a rear axle, in particular a multi-link rear axle, preferably an axle of motor vehicles that is driven with an electrical machine, for example an electric motor.

An auxiliary frame is a structural part of a motor vehicle, on which further components can be disposed. Possible components that can be disposed on the auxiliary frame are stabilizers, links, drive assemblies, differentials.

In most cases, the auxiliary frame consists of aluminum or steel or alloys of the aforementioned materials, and can be configured in one piece or multiple pieces.

Multi-link axles having only links disposed transversely and at a slant, in particular, require auxiliary frames, because the high link forces cannot be passed on directly to the body, and the longitudinal elasticity of the suspension can be improved by means of the soft mounting of the subframe.

Auxiliary frames can be produced using a great number of production methods. Known methods are:
multiple pieces of sheet metal welded together,
pipe structure (steel or aluminum) formed using internal high pressure (IHP),
combination of pipe and sheet metal (steel or aluminum),
aluminum low-pressure casting, chill casting or die-casting,
sheet/pipe with cast nodes.

The present invention is based on the task of configuring an auxiliary frame for the above-mentioned axles in more versatile manner, producing it more efficiently and less expensively, saving weight in this process, and ensuring sufficient rigidity in this regard. Furthermore, it is a task of the invention to demonstrate great rigidity in the transverse direction, to increase the longitudinal elasticity in the longitudinal direction and/or to support the elastokinematics of the wheel suspension.

According to the invention, for this purpose an auxiliary frame for a rear axle, particularly a multi-link rear axle, preferably an axle of a motor vehicle, which axle is driven with an electrical machine, for example an electric motor, is provided, comprising two lateral side members that are spaced apart from one another and are connected with one another by way of a rear cross member, viewed in the direction of travel.

The auxiliary frame according to the invention takes up little construction space in the motor vehicle, due to its compact construction. Nevertheless, the auxiliary frame and the components disposed on the auxiliary frame are easily accessible, which allows easy installation and removal of the auxiliary frame as well as of the components disposed on the auxiliary frame. Furthermore, the auxiliary frame allows easy access to the components disposed on the auxiliary frame, due to its construction, particularly the positioning of gaps, so that these components can be adjusted even in the installed state. A great number of accommodations can be provided on or in the auxiliary frame, in order to allow simplified placement of the individual components on the auxiliary frame.

The auxiliary frame according to the invention can be produced on one part or one piece, by means of a casting method, for example. An auxiliary frame formed in one part or one piece has the advantage that the individual regions of the auxiliary frame are not connected with one another by means of weld seams. In this way, increased long-term strength along with improved elasticity can be achieved.

The auxiliary frame according to the invention can be produced with reduced use of material due to the placement of gaps and reinforcement ribs. Due to the reduced use of material, the auxiliary frame can be produced in comparatively cost-advantageous manner, and furthermore has a reduced weight. In this regard, the gaps and reinforcement ribs are disposed on or in the auxiliary frame in such a manner that improved rigidity, improved crash behavior as well as more advantageous natural frequencies of the auxiliary frame are achieved.

It can be advantageous if the rear cross member has a wall disposed essentially vertically relative to the direction of travel.

It can be advantageous if accommodations for attachment of the auxiliary frame to the vehicle body are provided, wherein the accommodations for attachment of the auxiliary frame to the vehicle body are preferably connected in one piece with the auxiliary frame.

It can be advantageous if the accommodations for attachment of the auxiliary frame to the vehicle body are disposed in the end region of the side members.

It can be advantageous if the rear cross member has an upper wall disposed essentially horizontally relative to the direction of travel.

It can be advantageous if the upper wall of the rear cross member, which is disposed essentially horizontally relative to the direction of travel, follows the wall of the rear cross member that is disposed vertically relative to the direction of travel, in the upper region of this wall, to form a type of profile.

It can be advantageous if the upper wall of the rear cross member, which is disposed essentially horizontally relative to the direction of travel, follows the rear accommodations for attachment of the auxiliary frame to the vehicle body.

It can be advantageous if the rear cross member has a cross brace, particularly disposed in the lower region of the rear cross member, which brace is particularly configured as a wall or a type of double-L profile or a type of U profile.

It can be advantageous if the cross brace is configured in one part with the wall that is disposed essentially vertically relative to the direction of travel.

It can be advantageous if the side members each have a cantilever that faces the other side member and is at a distance from the rear cross member, formed on in one piece, wherein a front cross member can be disposed between the cantilevers.

It can be advantageous if the cantilever formed on in one piece is configured, at least in part, by means of two reinforcement ribs, wherein the reinforcement ribs enclose an angle, particularly an angle less than 90°, relative to one another, and advantageously, at least one of the reinforcement ribs can have a passage opening.

It can be advantageous if the cantilevers that are formed on in one piece has a reinforcement rib, particularly one disposed on a lower edge of a cantilever that is formed on in one piece.

It can be advantageous if the construction space situated between the side members and the cross members serves for accommodation of an electrical machine having power electronics.

It can be advantageous if the front cross member is attached to the cantilevers so that it can be released again, preferably by means of screws.

It can be advantageous if the front cross member is configured as a wall disposed essentially vertically relative to the direction of travel.

It can be advantageous if the front cross member, particularly the wall disposed essentially vertically relative to the direction of travel, has a reinforcement rib, particularly one disposed on a lower edge of the cross member.

It can be advantageous if the reinforcement ribs of the cantilevers that are formed on in one piece follows the reinforcement rib of the front cross member.

It can be advantageous if the top side of the side members has at least one recess or passage opening in the region between the cantilevers that are formed on in one piece and the rear cross member.

It can be advantageous if the side member, particularly every side member, has an accommodation for mounting a rear upper suspension arm or wishbone, wherein the accommodation for mounting a rear upper suspension arm or wishbone is preferably connected with the side member in one piece.

It can be advantageous if the accommodation for mounting of the upper suspension arm or wishbone is disposed, at least in part, in the upper wall of the respective rear cross member and adjacent, in each instance, to the rear accommodation for attachment of the auxiliary frame to the vehicle body.

It can be advantageous if the accommodation for mounting of the suspension arm has two accommodation elements disposed at a distance from one another for surrounding and holding the bearing of a suspension arm.

It can be advantageous if the side member, particularly every side member, has an accommodation for mounting a front upper suspension arm, wherein the accommodation for mounting a front upper suspension arm is preferably connected with the side member in one piece.

It can be advantageous if the accommodation for mounting of the front upper suspension arm has two accommodation elements disposed at a distance from one another for surrounding and holding the bearing of a suspension arm.

It can be advantageous if the accommodation for mounting of the front upper suspension arm is disposed in the region between the cantilevers that are formed on in one piece and the rear cross member, particularly in the transition region to the reinforcement rib.

It can be advantageous if the side member, particularly every side member, has an accommodation for mounting of a front upper suspension arm or wishbone, wherein the accommodation for mounting of a front upper suspension arm or wishbone is preferably connected in on piece with the side member.

It can be advantageous if the side member, particularly every side member, has an accommodation for mounting of a front lower suspension arm or wishbone, wherein the accommodation is preferably connected in one piece with the side member.

It can be advantageous if the accommodation for mounting of the front lower suspension arm has two accommodation elements disposed at a distance from one another for surrounding and holding the bearing of a suspension arm or wishbone.

It can be advantageous if the accommodation for mounting of the front lower suspension arm or wishbone has two accommodation elements disposed at a distance from one another, preferably at a slant relative to the longitudinal vehicle axis, for surrounding and holding the bearing of a suspension arm or wishbone.

It can be advantageous if the accommodation for mounting of the front lower suspension arm or wishbone is disposed in the region between the cantilevers that are formed on in one piece and the accommodations for attachment of the auxiliary frame to the vehicle body.

It can be advantageous if the side member, particularly every side member, is provided an accommodation for mounting of a lower spring link, wherein the accommodation for mounting of a lower spring link is preferably connected in one piece with the side member.

It can be advantageous if the accommodation for mounting of a spring link is disposed in the transition region to the wall that is essentially oriented vertically or the cross brace of the rear cross member.

It can be advantageous if the accommodation for mounting of the spring link has two accommodation elements that are at a distance from one another, at least approximately vertically relative to the longitudinal vehicle axis, for surrounding and holding the bearing of a spring link.

It can be advantageous if the cross brace follows the side members in the region of the accommodations for mounting of the spring link.

It can be advantageous if at least one, preferably three connection points for attachment or mounting of an active steering or rear axle steering are provided, wherein the connection points are preferably connected in one piece with the auxiliary frame.

It can be advantageous if the one or more than one connection point is disposed in the rear cross member, preferably in the wall of the rear cross member that is oriented essentially vertically relative to the direction of travel, wherein in particular, the steering is to be disposed on the side of the cross member that lies opposite the direction of travel.

It can be advantageous if the side member, particularly every side member, has an accommodation for mounting of a tie rod, wherein the accommodation for mounting of a tie rod is preferably connected in one piece with the side member.

It can be advantageous if the accommodation for mounting of a tie rod is disposed in the transition region between the wall of the rear cross member that is essentially oriented vertically.

It can be advantageous if the accommodation for mounting of a tie rod is disposed behind the cross member, viewed in the direction of travel.

It can be advantageous if the accommodation for mounting of the tie rod has two accommodation elements that are at a distance from one another vertically relative to the longitudinal axis of the vehicle, for surrounding and holding the tie rod.

It can be advantageous if the side member has a passage opening in the region of the rear cross member and at the level of the accommodation for mounting of a lower spring link.

It can be advantageous if accommodations for mounting of a motor/transmission unit or of the electrical machine, in particular the electric motor including power electronics are provided.

It can be advantageous if at least a partial region of the accommodation for mounting of a motor/transmission unit or of the electrical machine is formed by the cross brace.

It can be advantageous if the accommodation for mounting of a motor/transmission Unit or of the electrical machine follows the cross brace, at least in part.

It can be advantageous if the side member, particularly every side member, has an accommodation for mounting of the motor/transmission unit or of the electrical machine, which accommodation is oriented transversely relative to the direction of travel and disposed in the rear region of the auxiliary frame.

It can be advantageous if the accommodation for mounting of a motor/transmission unit or of the electrical machine is disposed in the region between the cantilevers that are formed on in one piece and the rear cross member.

It can be advantageous if the wall of the rear cross member, which is oriented essentially vertically relative to the direction of travel, has two accommodations for mounting of the motor/transmission unit or of the electrical machine, which are oriented in the direction of travel and disposed in the rear region of the auxiliary frame.

It can be advantageous if the auxiliary frame consists of a light-metal alloy.

It can be advantageous if the auxiliary frame consists of an aluminum alloy.

It can be advantageous if the auxiliary frame is cast in one piece, composed of side members and the rear cross member.

It can be advantageous if the auxiliary frame is die-cast.

It can be advantageous if the auxiliary frame is heat-treated.

It can be advantageous if the the side member(s) and/or the rear cross member have recesses or passage openings, particularly ones that save weight and are introduced on one side, which particularly serve to save weight, but also ensure sufficient strength of the auxiliary frame due to their placement and/or geometry. The invention relates, in this regard, also to the placement and/or geometry of individual gaps, groups of individual gaps, or all gaps introduced on one side or passing through the side members and/or the rear cross member.

Further developments and advantageous embodiments of the invention can also become evident from the following description of exemplary embodiments, which are shown in the drawing. Characteristics that are essential to the invention can also result from the placement of individual accommodations and/or accommodation elements and/or connection points and/or reinforcement ribs and/or passage openings relative to one another and/or relative to the side member and/or cross member. The drawing shows:

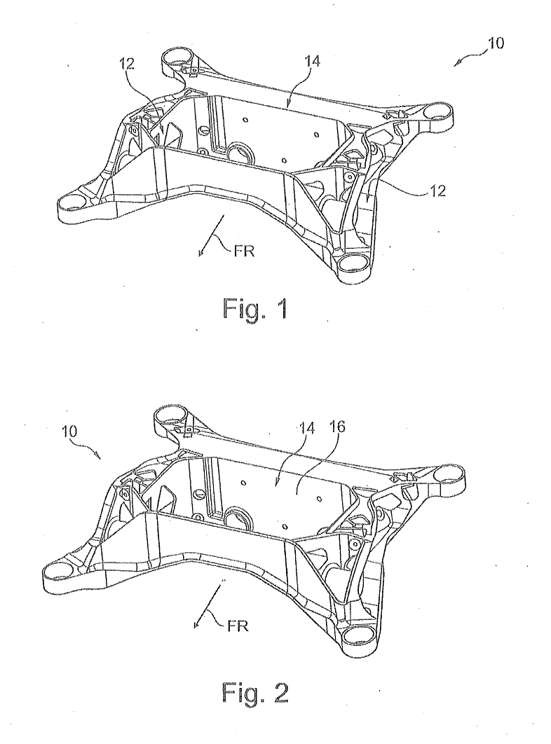

FIG. 1 a first perspective view of a first exemplary embodiment of an auxiliary frame according to the invention,

FIG. 2 a first perspective view of a first exemplary embodiment of an auxiliary frame according to the invention,

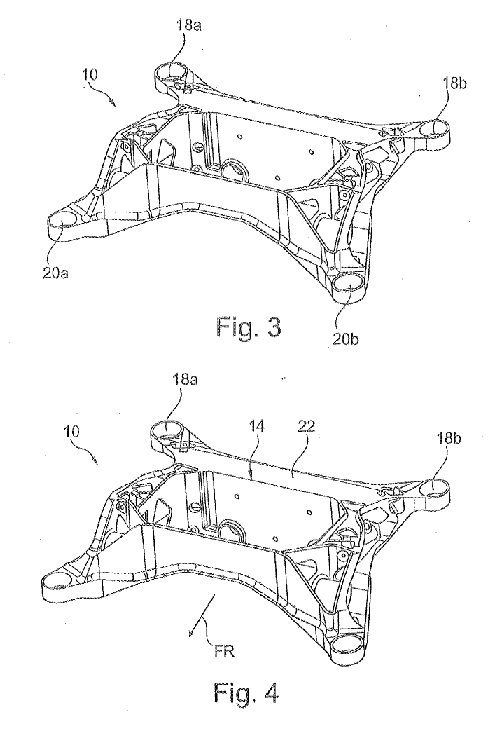

FIG. 3 a first perspective view of a first exemplary embodiment of an auxiliary frame according to the invention,

FIG. 4 a first perspective view of a first exemplary embodiment of an auxiliary frame according to the invention,

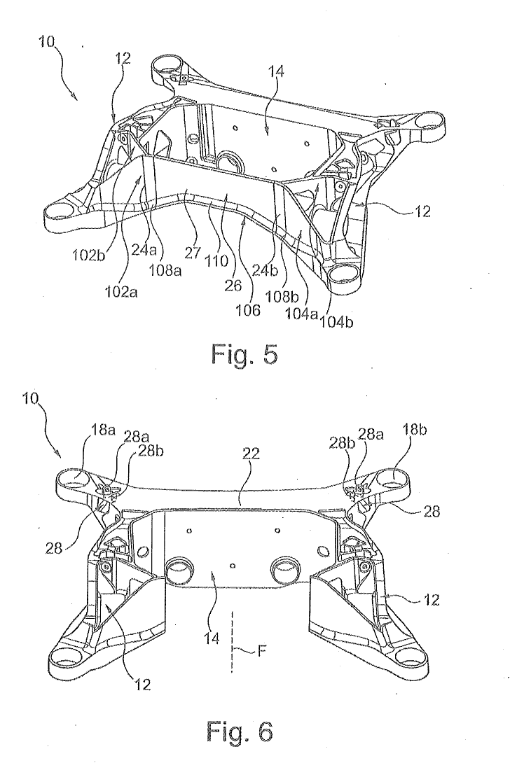

FIG. 5 a first perspective view of a first exemplary embodiment of an auxiliary frame according to the invention,

FIG. 6 a first perspective view of a second exemplary embodiment of an auxiliary frame according to the invention,

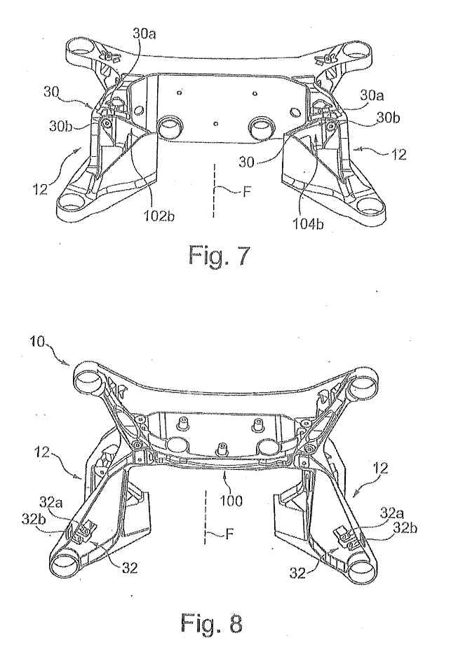

FIG. 7 a first perspective view of a second exemplary embodiment of an auxiliary frame according to the invention,

FIG. 8 a second perspective view of a second exemplary embodiment of an auxiliary frame according to the invention,

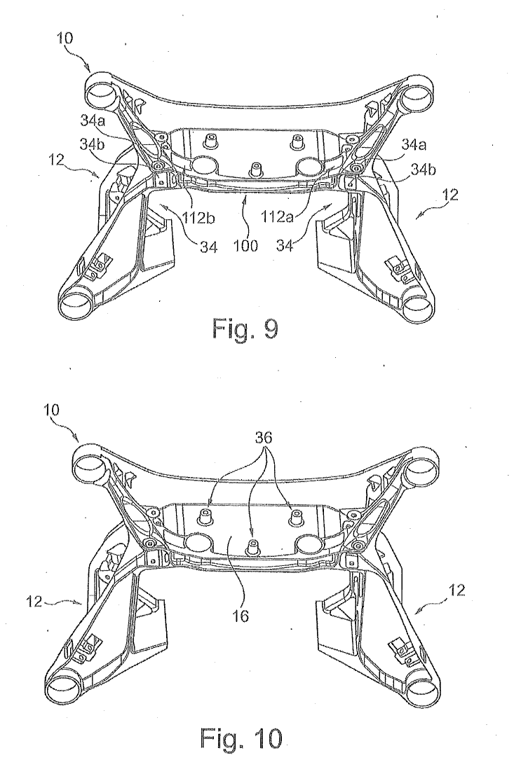

FIG. 9 a second perspective view of a second exemplary embodiment of an auxiliary frame according to the invention,

FIG. 10 a second perspective view of a second exemplary embodiment of an auxiliary frame according to the invention,

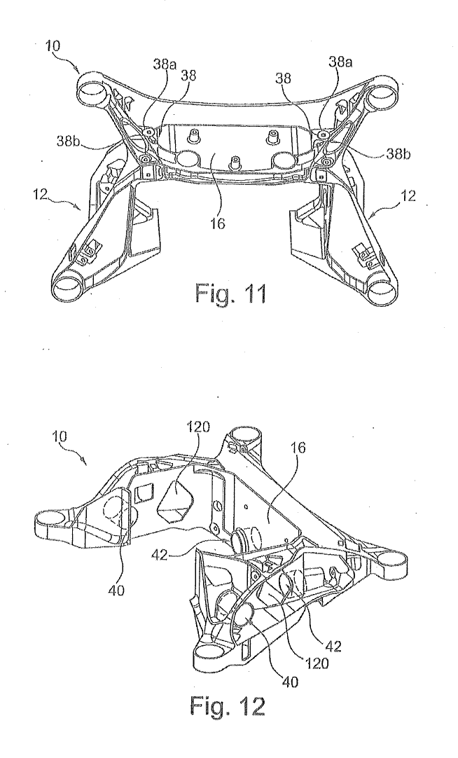

FIG. 11 a second perspective view of a second exemplary embodiment of an auxiliary frame according to the invention,

FIG. 12 a third perspective view of a second exemplary embodiment of an auxiliary frame according to the invention,

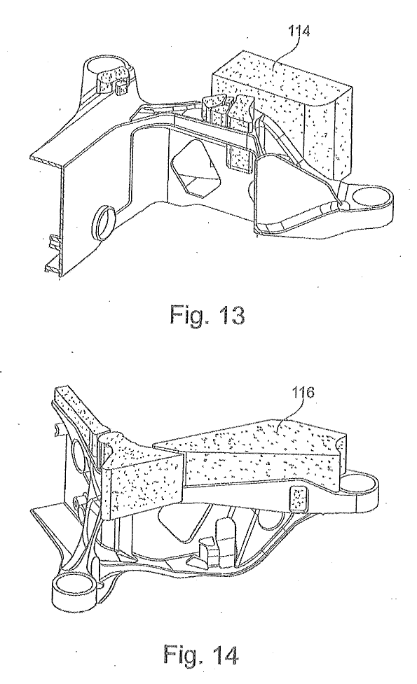

FIG. 13 a first perspective view of a detail of an auxiliary frame according to the invention as an unfinished part, with mold sand disposed on it,

FIG. 14 a second perspective view of a detail of an auxiliary frame according to the invention as an unfinished part, with mold sand disposed on it,

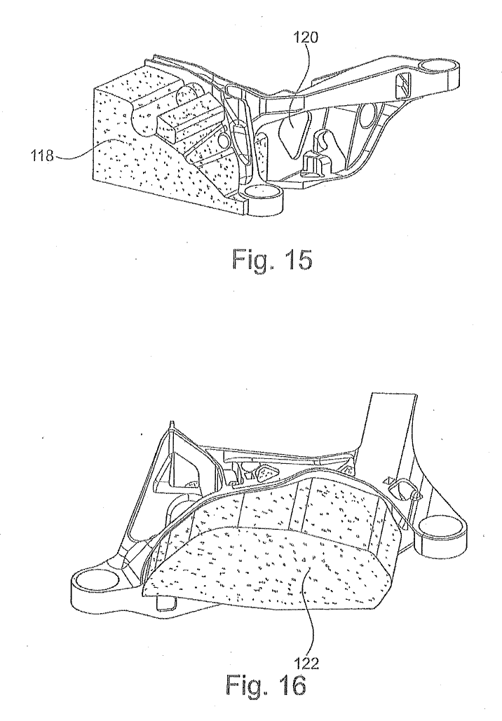

FIG. 15 a third perspective view of a detail of an auxiliary frame according to the invention as an unfinished part, with a slider disposed on it,

FIG. 16 a fourth perspective view of a detail of an auxiliary frame according to the invention as an unfinished part, with a slider disposed on it.

When the same reference numbers are used in FIGS. 1 to 12, they refer to the same parts, so that for the purpose of avoiding repetition, a component that has already been described does not need to be discussed again in every figure description.

The single difference between the two embodiments shown consists in that the first embodiment comprises a front cross member 26, in relation to the direction of travel FR, which is not shown in the second embodiment, but can be supplemented in it. Consequently, all the statements made in the figure description, particularly those regarding the placement of individual accommodations and/or accommodation elements and/or connection points and/or reinforcement ribs and/or passage openings that are made for the first embodiment also apply to the second embodiment, and vice versa.

FIGS. 1 to 5 show a first perspective view of a first exemplary embodiment of an auxiliary frame 10 according to the invention. The auxiliary frame comprises two side members 12 that are at a distance from one another, a rear cross member 14, in relation to the direction of travel FR, and a front cross member 26, in relation to the direction of travel FR. The side members 12 and cross members 14, 26 are disposed relative to one another, in this regard, that a side member 12 encloses an angle of 90° with a cross member 14, 26 at least to the greatest possible extent. The side members 12 and the rear cross member 14 are configured in one piece with one another.

The rear cross member 14 has a rear vertical wall 16, oriented essentially vertically relative to the direction of travel FR. Furthermore, the rear cross member 14 has a rear upper horizontal wall 22 that is oriented essentially horizontally relative to the direction of travel. The lateral edge regions of the rear vertical wall 16 make a transition, at least in part, into regions of the side members 12. The upper edge region of the rear vertical wall 16 make a transition, at least in part, into a front edge region of the rear upper horizontal wall 22. The rear vertical wall 16 and the rear upper horizontal wall 22 are disposed relative to one another, in this regard, in such a manner that the rear vertical wall 16 and the rear upper horizontal wall 22 enclose an angle of 90°, at least to the greatest possible extent, and thereby form a type of L profile. The rear vertical wall 16 and the rear upper horizontal wall 22 are configured in one piece with one another.

In the end region of the side members 12, the auxiliary frame 10 has accommodations 18a, 18b, 20a, 20b, which are provided for attachment of the auxiliary frame to the vehicle body. The accommodations 18a, 18b, 20a, 20b are structured as passage openings in the form of a hollow cylinder, and are connected in one piece with the auxiliary frame 10. The accommodations 18a, 18b are disposed in such a manner that the rear upper horizontal wall 22 of the rear cross member 14 follows the accommodations 18a, 18b at least in part.

At a distance from the rear cross member 14, the side members 12 have cantilevers 24a, 24b that are formed on in one piece. The cantilevers 24a, 24b are configured, at least in part, by means of two reinforcement ribs 102a, 102b and 104a, 104b, respectively; wherein the reinforcement ribs 102a, 102b or 104a, 104b enclose an angle of less than 90° relative to one another, and the reinforcement rib 102b, 104b has a passage opening. At a lower edge 106, the reinforcement rib 102a, 104a has a reinforcement rib 108a, 108b. The reinforcement rib 108a or 108b and the reinforcement rib 102a or 104a are configured in one piece with one another.

The front cross member 26 is disposed between these cantilevers 24a, 24b, wherein the front cross member 26 is releasably connected with the cantilevers 24a, 24b. The front cross member has a front vertical wall 27 that is disposed essentially vertically relative to the direction of travel FR, wherein a reinforcement rib 110 that is formed on in one piece is disposed at the lower edge 106 of the front vertical wall 27. The lateral edge regions of the front cross member 26 make a flush transition into the lateral edge regions of the cantilevers 24a, 24b. The reinforcement rib 110 of the front cross member 26, in particular, makes a flush transition into the reinforcement ribs 108a, 108b in the lateral edge regions.

On its top side, the side member 12 has at least two passage openings in the region between the cantilevers 24a, 24b that are formed on in one piece and the rear cross member 14, as well as further passage openings and/or recesses.

FIGS. 6 to 7 show a first perspective view of a second exemplary embodiment of an auxiliary frame 10 according to the invention. The auxiliary frame comprises two side members 12 that are at a distance from one another, a rear cross member 14 in relation to the direction of travel FR, and a front cross member 26 in relation to the direction of travel FR. The side members 12 and cross members 14, 26 are disposed relative to one another, in this regard, in such a manner that a side member 12 encloses an angle of 90° with a cross member 14, 26, at least to the greatest possible extent. The side members 12 and the rear cross member 14 are configured in one piece with one another.

In the region of the transition of the rear cross member 14, particularly of the rear upper horizontal wall 22 into the side member 12, particularly of the rear attachment accommodation 18a, 18b, the auxiliary frame 10 has an accommodation 28 for mounting of a rear upper suspension arm, configured in one piece with the side member 12, wherein the accommodation 28 comprises two accommodation elements 28a, 28b that are at a distance from one another. The accommodation elements 28a, 28b are structured as two plane-parallel flat regions, which each have a passage opening. A bearing of a suspension arm can be fixed in place, in surrounding manner, between the accommodation elements 28a, 28b.

Between the cantilever 24a, 24b and the rear cross member 14, the auxiliary frame 10 has an accommodation 30 for mounting of a front upper suspension arm, configured in one piece with the side arm 12, in the region of the transition of the cantilever 24a, 24b, particularly of the reinforcement rib 102b, 104b into the side arm 12, wherein the accommodation 30 comprises two accommodation elements 30a, 30b that are at a distance from one another. The accommodation elements 30a, 30b are structured as two plane-parallel flat regions, which each have a passage opening. A bearing of a suspension arm can be fixed in place between the accommodation elements 30a, 30b, in surrounding manner.

FIGS. 8 to 11 show a second perspective view of a second exemplary embodiment of an auxiliary frame 10 according to the invention.

The rear cross member 14 has a rear cross brace 100 that is oriented essentially horizontally relative to the direction of travel FR. The cross brace 100 has a profile that is in the shape of a double L or a U, to the greatest possible extent. The lateral edge regions of the rear cross brace 100 make a transition, at least in part, into regions of the side members 12. A front edge region of the rear cross brace 100 makes a transition, at least in part, into a lower edge region of the rear vertical wall 16. The rear vertical wall 16 and the rear cross brace 100 are disposed relative to one another, in this regard, in such a manner that the rear vertical wall 16 and the rear cross brace 100 enclose an angle of 90°, at least to the greatest possible extent, and thereby form a type of L profile. The rear vertical wall 16 and the rear cross brace are connected in one piece with one another.

Between the cantilever 24a, 24b and the front attachment accommodation 20a, 20b, the auxiliary frame 10 has an accommodation 32 for mounting of a front lower suspension arm, configured in one piece with the side member 12, wherein the accommodation 32 comprises two accommodation elements 32a, 32b that are at a distance from one another. The accommodation elements 32a, 32b are structured as two plane-parallel flat regions, which each have a passage opening. A bearing of a suspension arm can be fixed in place between the accommodation elements 32a, 32b, in surrounding manner.

In the region of the transition of the rear cross member 14, particularly of the rear vertical wall 16 or the rear cross brace 100, into the side member 12, the auxiliary frame 10 has an accommodation 34 for mounting of a lower spring link, configured in one piece with the side member 12, wherein the accommodation 34 comprises two accommodation elements 34a, 34b that are at a distance from one another. The accommodation elements 34a, 34b are structured as two plane-parallel flat regions that each have a passage opening, and the flat regions are oriented approximately perpendicular to the longitudinal axis F of the vehicle. A bearing of a spring link can be fixed in place between the accommodation elements 34a, 34b, in surrounding manner.

Furthermore, the side member 12 has a passage opening 112a, 112b in the transition region to the rear cross member 14, particularly of the rear cross brace 100, at the level of the accommodation 34 for mounting of a lower spring link.

The rear vertical wall 16 has three connection points 36 for attachment of an active steering, which points are configured as passage openings, in one piece with the rear vertical wall 16, and each form an extension on the back of the rear vertical wall 16. The three connection points 36 are disposed in the form of a triangle, wherein the base side of the triangle formed is oriented parallel, at least to the greatest possible extent, to the rear upper parallel wall 22.

Between the rear cross member 14 and the rear attachment accommodations 18a, 18b, the auxiliary frame 10 has an accommodation 38 for mounting of a tie rod, formed in one piece with the side member 12, wherein the accommodation 38 comprises two accommodation elements 38a, 38b that are at a distance from one another. The accommodation elements 38a, 38b are structured as two plane-parallel flat regions, which each have a passage opening, and the flat regions are oriented approximately perpendicular to the longitudinal axis F of the vehicle. A bearing of a tie rod can be fixed in place between the accommodation elements 38a, 38b, in surrounding manner.

The rear cross member 14 has two accommodations 42 for mounting of a motor/transmission unit, wherein the accommodations 42 are structured as passage openings in the shape of a hollow cylinder and are configured in one piece with the rear cross member 14. The passage openings are oriented parallel to the longitudinal axis F of the vehicle, at least to the greatest possible extent. The accommodations 42 are disposed in the transition region of the rear vertical wall 16 and the rear cross brace 100, wherein a partial region of the accommodation 42 is formed by the rear vertical wall 16, and a further partial region of the accommodation 42 is formed by the rear cross brace 100. The accommodation 42 ends flush with the cross brace 100 on the side of the rear cross brace 100 that faces away from the rear vertical wall 16.

FIG. 12 shows a third perspective view of a second exemplary embodiment of an auxiliary frame 10 according to the invention. In the region of the cantilever 24a, 24b, particularly in the transition region of the reinforcement rib 102b 104b into the side member 12, the auxiliary frame 10 has an accommodation 40 for mounting of a motor/transmission unit, configured in one piece with the side member 12, wherein the accommodation 40 is configured as passage openings in the form of a hollow cylinder. The passage openings are oriented perpendicular to the longitudinal axis F of the vehicle, at least to the greatest possible extent.

FIG. 13 shows a first perspective view of a detail of an auxiliary frame 10 according to the invention as an unfinished part, with mold sand 114 disposed on it. The mold sand 114 forms planned gaps according to the invention during casting of the auxiliary frame 10, particularly the the recesses and/or passage openings between the cantilevers 24a, 24b that are formed on in one piece and the rear cross member 14, on the top side of the side member 12.

FIG. 14 shows a second perspective view of a detail of an auxiliary frame 10 according to the invention as an unfinished part, with mold sand 116 disposed on it. The mold sand 116 forms planned gaps according to the invention during casting of the auxiliary frame 10.

FIG. 15 shows a third perspective view of a detail of an auxiliary frame 10 according to the invention as an unfinished part, with a slider 118 disposed on it. The slider 118 forms planned gaps according to the invention during casting of the auxiliary frame 10, particularly the accommodations 42 for mounting of a motor/transmission unit.

FIG. 16 shows a fourth perspective view of a detail of an auxiliary frame 10 according to the invention as an unfinished part, with a slider 122 disposed on it. The slider 122 forms planned gaps according to the invention during casting of the auxiliary frame 10, particularly the accommodation 40 for mounting of a motor/transmission unit. The slider 122 is also provided for forming the passage opening 120, which is essentially in square shape.

### REFERENCE SYMBOL LIST

(is part of the specification)
10 auxiliary frame
12 side member
14 rear cross member
16 rear vertical wall
18a, 18b rear attachment accommodations
20a, 20b front attachment accommodations
22 rear upper horizontal wall
24a, 24b cantilevers
26 front cross member
27 front vertical wall
28 accommodation (rear upper suspension arm)
28a, 28b rear attachment accommodations
30 accommodation (front upper suspension arm)
30a, 30b accommodation elements
32 accommodation (front lower suspension arm)
32a, 32b accommodation elements
34 accommodation (lower spring link)
34a, 34b accommodation elements
36 connection point
38 accommodation (tie rod)
40 attachment accommodation
42 attachment accommodation
100 rear cross brace
102a, 102b reinforcement rib
104a, 104b reinforcement rib
106 edge
108a, 108b reinforcement rib
110 reinforcement rib
112a, 112b passage opening
114 molding sand
116 molding sand
118 slider
120 passage opening
122 slider
FR direction of travel
F longitudinal axis of vehicle

1. Auxiliary frame (10) for a rear axle, which axle is driven with an electrical machine, comprising two lateral side members (12) that are spaced apart from one another and are connected with one another by way of a rear cross member (14), viewed in the direction of travel (FR).

2. Auxiliary frame (10) according to claim 1, wherein the rear cross member (14) has a wall (16) disposed essentially vertically relative to the direction of travel (FR).

3. Auxiliary frame (10) according to claim 1, wherein accommodations (18a, 18b, 20a, 20b) for attachment of the auxiliary frame (10) to the vehicle body are provided, wherein the accommodations (18a, 18b, 20a, 20b) are connected in one piece with the auxiliary frame.

4. Auxiliary frame according to claim 1, wherein the accommodations (18a, 18b, 20a, 20b) for attachment of the auxiliary frame (10) to the vehicle body are disposed in the end region of the side members (12), in each instance.

5. Auxiliary frame (10) according to claim 1, wherein the rear cross member (14) has an upper wall (22) disposed essentially horizontally relative to the direction of travel (FR).

6. Auxiliary frame (10) according to claim 1, wherein the upper wall (22) of the rear cross member (14), which is disposed essentially horizontally relative to the direction of travel (FR), follows the wall (16) of the rear cross member (14), which wall is disposed vertically relative to the direction of travel (FR), in its upper region, to form a type of L profile.

7. Auxiliary frame (10) according to claim 1, wherein the upper wall (22) of the rear cross member (14), which wall is disposed essentially horizontally relative to the direction of travel (FR), follows the rear accommodations (18a, 18b) for attachment of the auxiliary frame (10) to the vehicle body.

8. Auxiliary frame (10) according to claim 1, wherein the rear cross member (14) has a cross brace (100) disposed in the lower region of the rear cross member (14), which is configured, in particular, as a wall or as a type of double-L profile or a type of U profile.

9. Auxiliary frame (10) according to claim 1, wherein the cross brace (100) is configured in one part with the wall (16) that is disposed essentially vertically relative to the direction of travel (FR).

10. Auxiliary frame (10) according to claim 1, wherein the side members (12) each have a cantilever (24a, 24b) that faces toward the other side member (12) and is at a distance from the cross member (14), which cantilever is formed on in one piece, wherein a front cross member (26) can be disposed between the cantilevers.

11. Auxiliary frame (10) according to claim 1, wherein the cantilever (24a, 24b) that is formed on in one piece is configured, at least in part, by means of two reinforcement ribs (102a, 102b, 104a, 104b), wherein the reinforcement ribs (102a, 102b, 104a, 104b) enclose an angle less than 90° relative to one another, and at least one of the reinforcement ribs (102a, 102b, 104a, 104b) can have a passage opening.

12. Auxiliary frame (10) according to claim 1, wherein the cantilevers (24a, 24b) that are formed on in one piece has a reinforcement rib (108a, 108b) disposed on a lower edge (106) of a cantilever (24a, 24b) that is formed on in one piece.

13. Auxiliary frame (10) according to claim 1, wherein the construction space situated between the side members (12) and the cross members (14, 26) serves for accommodation of an electrical machine having power electronics.

14. Auxiliary frame (10) according to claim 1, wherein the front cross member (26) is attached to the cantilevers (24a, 24b) in releasable manner.

15. Auxiliary frame (10) according to claim 1, wherein the front cross member (26) is configured as a wall (27) disposed essentially vertically relative to the direction of travel (FR).

16. Auxiliary frame (10) according to claim 1, wherein the front cross member (26) has a reinforcement rib (110) disposed on a lower edge (106) of the cross member (26).

17. Auxiliary frame (10) according to claim 1, wherein the reinforcement ribs (108a, 108b) of the cantilevers (24a, 24b) that are formed on in one piece follow the reinforcement rib (110) of the front cross member (26).

18. Auxiliary frame (10) according to claim 1, wherein the top side of the side members (12) has at least one recess or passage opening in the region between the cantilevers (24a, 24b) that are formed on in one piece and the rear cross member (14).

19. Auxiliary frame (10) according to claim 1, wherein every side member has an accommodation (28) for mounting of a rear upper suspension arm, wherein the accommodation (28) is connected in one piece with the side member (12).

20. Auxiliary frame (10) according to claim 1, wherein the accommodation (28) for mounting of the upper suspension arm is disposed, at least in part, in the upper wall (22) of the respective rear cross member (14) and adjacent, in each instance, to the rear accommodation (18a, 18b) for attachment of the auxiliary frame (10) to the vehicle body.

21. (canceled)

22. Auxiliary frame (10) according to claim 1, wherein every side member has an accommodation (30) for mounting of a front upper suspension arm, wherein the accommodation (30) is connected in one piece with the side member (12).

23. (canceled)

24. Auxiliary frame (10) according to claim 1, wherein the accommodation (30) for mounting of the front upper suspension arm is disposed in the region between the cantilevers (24a, 24b) that are formed on in one piece and the rear cross member (14).

25. Auxiliary frame (10) according to claim 1, wherein every side member has an accommodation (32) for mounting of a front lower suspension arm, wherein the accommodation (32) is connected in one piece with the side member (12).

26. (canceled)

27. Auxiliary frame (10) according to claim 1, wherein the accommodation (32) is disposed on the region between the cantilevers (24a, 24b) that are formed on in one piece and the accommodations (20a, 20b).

28. Auxiliary frame (10) according to claim 1, wherein every side member, is provided an accommodation (34) for mounting of a lower spring link, wherein the accommodation (34) is connected in one piece with the side member (12).

29. Auxiliary frame (10) according to claim 1, wherein the accommodation (34) for mounting of a spring link is disposed in the transition region to the wall (16), which is oriented essentially vertically, or the cross brace (100) of the rear cross member (14).

30. (canceled)

31. Auxiliary frame (10) according to claim 1, wherein the cross brace (100) follows the side member (12) in the region of the accommodations (34).

32. Auxiliary frame (10) according to claim 1, wherein three connection points (36) for attachment of an active steering are provided, wherein the connection points (36) are connected in one piece with the auxiliary frame (10).

33. Auxiliary frame (10) according to claim 1, wherein the connection points (36) are disposed in the rear cross member (14).

34. Auxiliary frame (10) according to claim 1, wherein the side member (12) is provided an accommodation (38) for mounting of a tie rod, wherein the accommodation (38) is preferably connected in one piece with the side member (12).

35. Auxiliary frame (10) according to claim 34, wherein the accommodation (38) for mounting of a tie rod is disposed in the transition region to the wall (16) of the rear cross member (14), which wall is disposed essentially vertically.

36. Auxiliary frame (10) according to claim 34, wherein the accommodation (38) is disposed behind the cross member viewed in the direction of travel (FR).

37. (canceled)

38. Auxiliary frame (10) according to claim 1, wherein the side member (12) has a passage opening (112a, 112b) in the region of the rear cross member (14) and at the level of the accommodation (34) for mounting of a lower spring link.

39. Auxiliary frame (10) according to claim 1, wherein accommodations (40, 42) are provided for mounting of a motor/transmission unit.

40. Auxiliary frame (10) according to claim 39, wherein at least one partial region of the accommodation (42) is formed by the cross brace (100).

41. Auxiliary frame (10) according to claim 39, wherein the accommodation (42) follows the cross brace (100), at least in part.

42. Auxiliary frame (10) according to claim 1, wherein every side member has an accommodation (40) for mounting of the motor/transmission unit, which (40) is oriented transversely to the direction of travel (FR) and disposed in the rear region of the auxiliary frame.

43. Auxiliary frame (10) according to claim 42, wherein the accommodation (40) is disposed in the region between the cantilevers (24a, 24b) that are formed on in one piece and the rear cross member (14).

44. Auxiliary frame (10) according to claim 1, wherein the wall (16) of the rear cross member (14), which wall is oriented essentially vertically relative to the direction of travel, has two accommodations (42) for mounting of the motor/transmission unit, which are oriented in the direction of travel (FR) and disposed in the rear region of the auxiliary frame (10).

45. (canceled)

46. (canceled)

47. (canceled)

48. (canceled)

49. (canceled)
